(19) United States
(12) Patent Application Publication
(10) Pub. No.: US 2017/0293597 A1
(43) Pub. Date: Oct. 12, 2017

(54) METHODS AND SYSTEMS FOR DATA PROCESSING

(71) Applicants: Khalifa University of Science, Technology and Research, Abu Dhabi (AE); British Telecommunications Plc, London (GB); Emirates Telecommunications Corporation, Abu Dhabi (AE)

(72) Inventors: Di Wang, Abu Dhabi (AE); Ahmad Al-Rubaie, Abu Dhabi (AE)

(21) Appl. No.: 15/092,941

(22) Filed: Apr. 7, 2016

(51) Int. Cl. G06F 17/24; G06F 17/21; G06F 17/27

(52) U.S. Cl. CPC G06F 17/24; G06F 17/2705; G06F 17/2775; G06F 17/211

(57) ABSTRACT

This invention relates to methods and systems for message analysis and classification. It is particularly applicable to analysis and classification of very short messages such as “Tweets”. Embodiments of the invention provide methods for unbiased enriched representation for messages which can be used to transform very short messages into comparatively longer text. These methods can make use of word context information in addition to word information itself. This can provide text with enough information for analysis and classification without changing the information in the original message. Embodiments of the invention also provide a statistical learning mechanism which does not require pre-defined keywords, and can automatically detect inherent frequent words and word patterns. These methods can provide satisfactory classification accuracy even for very short messages.

### FIELD OF THE INVENTION

The present invention relates to methods and systems for processing of textual data. It is particularly, but not exclusively concerned with methods and systems for analysis and classification of very short messages.

### BACKGROUND OF THE INVENTION

In this application, “very short messages” are considered to be messages with no more than 300 characters, preferably no more than 200 characters, and most preferably no more than 140 characters (for example “tweets” as used on Twitter®). Alternatively or additionally, “very short messages” may be defined on the basis of the semantic length of the message, and includes messages having no more than 2 sentences (which need not be complete or grammatically correct).

The shorter a message is, the more variation is present in the textual contents (and for informal communications such as “tweets”, the variation is greater than in formal written text of the same length).

Very short message classification is currently dealt with as normal text classification, albeit with additional challenges resulting from the shortness of the messages and the informal text typically used in such messages.

The field of text classification itself is a subset of general classification problems; the difference being that, for text classification, it is necessary to extract words as features for the classifiers when applying general classification techniques. Generally used techniques for text classification include machine learning, and statistical methods.

Known machine learning methods include Support Vector Machine (SVM), artificial neural networks, decision tree, K-nearest neighbour algorithms, rough set and soft set classifier, etc. . . . Machine learning methods generally need the predefined or extracted words as features to make the machine learning methods work for text classifications. As a result keyword pre-definition/extraction and feature selection play a very important role in the final accuracy of the classifier. Improper keywords and features can result in low accuracy for the resulting classifier.

However, defining or extracting keywords is not an easy task. Among all machine learning methods, SVM is the most popular used technique for text classicisation problems. A considerable amount of work has been done on text classification problems in the past decades by using SVM and the other machine learning techniques mentioned above.

Statistical methods include Navie Bayes classifier, TF-IDF, Bag-of-Word (BOW) methods including latent semantic indexing, latent Dirichlet allocation, etc. Predefined or extracted words are not necessary for BOW methods for text classification problems. For example, Latent Dirichlet Allocation (LDA) is a popular statistical model for text classification problems without using predefined keywords. It automatically detects the word-topic distributions and topic distributions to build the topic model. A considerable amount of work has been done on text classification by using statistical methods.

As a special task of text classification problems, some work on very short message classification problems using the above techniques has been carried out. However almost all the mentioned techniques lose accuracy for very short message classification problems. From the reports and publications, the accuracy for very short message classification problems, e.g. for tweets, typically ranges between 40% and 80% based on different applications.

Technically speaking any classification technique can be used for text classifications, and therefore for very short message classification. But many of these techniques, e.g. neural networks and fuzzy systems require a predefined set of keywords.

The most popular technique used for text classification is SVM, which works comparatively well (assuming a well-defined keywords set) for text classifications in longer formal documents. The accuracy achieved is high and can exceed 90%.

However, when it comes to very short messages classification, there are two key issues with this approach: 1) how to define the keywords set; there is limited information within each very short message and people always tend to use informal expression with abbreviations, spelling errors, slangs and less correct grammar which makes the keywords definition (which has always been difficult for formal text) even more difficult for very short messages; and 2) how to obtain satisfactory accuracy for very short message classifications; statistical methods and machine learning techniques need considerable information to build up an accurate model and achieve satisfactory accuracy; however the lack of information in each very short message and the increased noise (caused by abbreviations, spelling errors and slang etc.) compared to formal text means very short messages generally cannot provide enough information to build up accurate models by using either statistical methods or machine learning techniques.

The first issue of the keyword set can be solved either manually by expert knowledge or automatically by using computational intelligence techniques. Automatic keyword detection/extraction includes feature selection (starting from an empty set and adding important words as keywords step by step, which finally produces the keywords set) and feature removal (starting from all words as keywords and removing words that do not contribute to the classification accuracy).

The final classification accuracy is highly dependent on how good the generated keywords set is. Whatever techniques are used for either feature selection or feature removal, the errors generated within this process will be accumulated during the later classification process, and reflected in the resulting classification accuracy. In most cases, if the keywords set is carefully generated, then SVM will be able to achieve satisfactory accuracy for formal longer documents.

However when the SVM plus keywords set techniques are applied to very short messages, e.g. tweets, they all lose their accuracy and sometimes the results are no better than random guesses. The failure of such techniques when applied to very short messages is generally due to one or more of the following reasons: 1) the limited information available from single very short messages; 2) the use of informal expressions with less correct grammar; 3) word variations including different forms of abbreviations for the same word; 4) the great amount of the daily data stream which needs to be analysed and classified which needs an accurate and efficient text analytics method/system; 5) large amounts of irrelevant/noisy information.

Points 2)-5) in the previous paragraph are generally related to noisy information, and have been addressed to a certain extent by applying pre-processing techniques such as removing more than two continuous repeated characters (no English word has more than two continuous repeated characters), stemming, removing stopping words, removing authors and url links, replacing notions to meaningful texts (e.g. :) to smile) etc, . . . .

As mentioned above, some techniques do not need keywords for text classification. Popular techniques used for text mining without predefined keywords are Bag-of-Words (BOW) techniques, an example of which is Latent Dirichlet Allocation (LDA). LDA is an unsupervised learning technique for clustering, which was later improved to incorporate supervised learning by adding the supervision to the learning process, hence it can be used for classifications. However the existing applications of LDA are still for formal and longer text classifications. In fact, as LDA is a statistical method, it needs enough text/document information to be present (reasonable length for each document) to generate satisfactory accuracy.

An n-gram model is a statistical model that is commonly used in computational linguistics and postulates that given a sequence of letters/words, what is the likelihood of the next letter/word? More concisely, an n-gram model predicts a letter/word on position i based on the letters/words on position i-1, i-2, . . . , i-n+1. The probability of a letter/word is conditioned on some number of previous letters/words.

The idea of n-gram has been applied to text mining, e.g. Roverteto Twitter N-Gram Corpus [1] contains the frequency statistics for phrases through time using n-gram model. Other work makes use of the results from n-gram models to select key phrases/terms which are jointly used with machine learning techniques, e.g. extracted key words/phrases plus SVM for text/short messages classification. Or in other words, n-gram models (e.g. in Roverteto) apply statistical methods to build up a probability dictionary based on the co-occurrence or frequencies of words following the words, and the resulting probability dictionary can be used on top of other techniques. For example, the resulting probability dictionary can be used to help with the feature/keywords selection before general classification techniques are used for text classification.

An object of the present invention is to provide a technique which allows a message, particularly a very short message, to be extended to improve the applicability of analysis techniques without changing the information the message itself carries. A further object is to provide a technique which allows further information content to be extracted from a message, particularly a very short message.

### SUMMARY OF THE INVENTION

An exemplary embodiment of the invention provides a method of processing textual data, the method including the steps of: segmenting the data into one or more fragments by selecting each part of the data which is separated from another part by punctuation indicating a conceptual break; extending each fragment of the data by appending to the fragment all possible ordered combinations of neighbouring words.

A further exemplary embodiment of the invention provides a computer program which, when run on a computer, performs the steps of: reading, from a data store or a data stream, textual data; segmenting the data into one or more fragments by selecting each part of the data which is separated from another part by punctuation indicating a conceptual break; extending each fragment of the data by appending to the fragment all possible ordered combinations of neighbouring words.

A further exemplary embodiment of the invention provides a system for processing textual data, the system including a memory and a processor, wherein the processor is arranged to: read, from the memory, textual data; segment the data into one or more fragments by selecting each part of the data which is separated from another part by punctuation indicating a conceptual break; extend each fragment of the data by appending to the fragment all possible ordered combinations of neighbouring words.

### BRIEF DESCRIPTION OF THE DRAWINGS

Embodiments of the invention will now be described by way of example with reference to the accompanying drawings in which:

FIG. 1 shows a system according to an embodiment of the present invention; and

FIG. 2 is a graph showing the classification accuracy of various classification methods applied to “tweet” data.

### DETAILED DESCRIPTION

At their broadest, aspects of the present invention provide for methods and systems which process textual data to enrich it in an unbiased fashion. In particular the methods and systems extend very short messages into comparatively longer text by conjoining meaningful neighbouring words.

A first aspect of the present invention provides a method of processing textual data, the method including the steps of: segmenting the data into one or more fragments by selecting each part of the data which is separated from another part by punctuation indicating a conceptual break; extending each fragment of the data by appending to the fragment all possible ordered combinations of neighbouring words.

Preferably the textual data is very short messages, i.e. messages with no more than 300 characters, preferably no more than 200 characters, and most preferably no more than 140 characters (for example “tweets” as used on Twitter®). Alternatively or additionally, the textual data may be messages having no more than 2 sentences (which need not be complete or grammatically correct). Existing methods are generally considered to work well for text longer than these limits, but their accuracy drops greatly when applied to very short messages, particularly those with fewer than 140 characters.

The shorter the textual data or message is, the more variation a text has. Moreover, very short messages tend to be characterised by informal textual usage (both spelling and grammar), which results in greater text variation in actual very short messages compared to formal written text of the same length. The shorter the textual data is (down to a theoretical minimum limit of one word), the more accuracy improvement the method of the present aspect can provide. This is because when traditional methods are applied to short text with large variations very poor accuracy is achieved. As the text starts to become longer and with less variation, the improvements provided by the method of the present aspect will reduce, but can still be significant.

By extending each fragment, the content of the data, particularly if it is short, can be enriched. This enriched representation of the data can be used for model building which can enable the use of existing text mining techniques to be applied to very short message mining directly and satisfactory accuracy obtained.

Further, the extension does not change the information contained in the data itself as it only makes use of the information within the data itself for its extension. Thus this extension is unbiased.

Thus the method of the present aspect can provide unbiased extension of data, such as messages, and in particular very short messages, to make them long enough to apply one or more existing text mining techniques currently used for formal long document classification at higher/acceptable levels of accuracy. Alternatively, the method of the present aspect can be used as pre-processing step for existing text mining/analysis techniques which can improve the accuracy of those techniques, particularly for shorter amounts of data.

The method of this aspect therefore can address the ‘not long enough’ characteristic of very short messages by converting a very short message by its unbiased enriched form (which results in longer text) without changing the statistic word (word pattern)-topic distribution. This can make it possible for any existing technique used for formal document classification to be applied to very short message classification and better accuracy achieved. In trials, the inventors have found that a 10% accuracy improvement can be readily achieved using embodiments of the present invention as opposed to using the same classification technique without the processing steps of the present aspect.

The method of the present aspect can be advantageous compared to n-gram models as it does not need any training data or pre-training process to generate an n-gram model or n-gram dictionary beforehand. It also does not require any complicated probability calculation as n-gram model does and it can make use of all information of ordered conjoint words to extend the very short message by universal unbiased conjoint of all possible continuous words beyond n-gram without involving any probability or frequency calculation.

Preferably the method further includes the step of, prior to segmenting, performing pre-processing steps to “clean” the data or render its content more appropriate for subsequent textual analysis.

For example, the method may further include the pre-processing steps of: cleaning the data to remove meaningless characters; and/or interpreting characters or character strings in the data which have no textual meaning into meaningful textual phrases.

In the step of extending, combinations of neighbouring words may be represented as one string with no spaces in between.

Preferably the method further includes the step of analysing the extended data.

Text classification techniques for analysing formal and long documents have been comparatively mature for decades and are able to achieve satisfactory accuracy provided that the data being analysed is sufficiently large. Any such techniques can be used in the analysis step.

Traditional techniques for formal long document classification include statistical methods and machine learning methods, most of which require pre-defined keywords set. This pre-defined keywords set is the key to achieving the satisfactory classification accuracy. A not-well-defined keywords set can lead to inaccurate classification. A small set of techniques do not need the pre-defined keywords set such as Latent Semantic Analysis (LSA), Latent Dirichlet Allocation (LDA), etc. The enriched representation of very short messages is combined with a statistical learning mechanism, such as LDA which does not need any keywords to be pre-defined but is able to automatically detect inherent frequent words and word patterns (frequent expressions) in each category automatically.

The method may also include other known pre-processing steps which aim to address problems associated with the noise in the data, for example: informal expression or varying/less correct grammar; word variations including different forms of abbreviations for the same word, spelling errors, slang, notions used to express information; and/or irrelevant/noisy information.

Preferably the method further includes the step of extracting, from the analysed data, phrases that are used frequently in the textual data. As the textual data has been enriched by combinations of adjacent words, key/frequent terms can be automatically detected. Terms are composed of more than one word; key/frequent terms reflect the frequently used word patterns in specified scenarios.

The method of this aspect inherently makes use of the word context information in addition to word information itself by appending to the fragment all possible ordered combinations of neighbouring words to achieve the unbiased extension. As the information that is used in text mining techniques is the words appearing in the data, the extension applied by the method of this aspect can also capture the relationship between words (which may go further than and be much richer than traditional semantic analysis) and therefore allow extraction of that relationship.

The method of the present aspect may include any combination of some, all or none of the above described preferred and optional features.

The method of the above aspect is preferably implemented by a computer program according to the second aspect of this invention, as described below, but need not be.

A second aspect of the present invention provides a computer program which, when run on a computer, performs the steps of: reading, from a data store or a data stream, textual data; segmenting the data into one or more fragments by selecting each part of the data which is separated from another part by punctuation indicating a conceptual break; extending each fragment of the data by appending to the fragment all possible ordered combinations of neighbouring words.

Preferably the textual data is very short messages, i.e. messages with no more than 300 characters, preferably no more than 200 characters, and most preferably no more than 140 characters (for example “tweets” as used on Twitter®). Alternatively or additionally, the textual data may be messages having no more than 2 sentences (which need not be complete or grammatically correct). Existing methods are generally considered to work well for text longer than these limits, but their accuracy drops greatly when applied to very short messages, particularly those with fewer than 140 characters.

The shorter the textual data or message is, the more variation a text has. Moreover, very short messages tend to be characterised by informal textual usage (both spelling and grammar), which results in greater text variation in actual very short messages compared to formal written text of the same length. The shorter the textual data is (down to a theoretical minimum limit of one word), the more accuracy improvement the program of the present aspect can provide. This is because when traditional methods are applied to short text with large variations very poor accuracy is achieved. As the text starts to become longer and with less variation, the improvements provided by the program of the present aspect will reduce, but can still be significant.

By extending each fragment, the content of the data, particularly if it is short, can be enriched. This enriched representation of the data can be used for model building which can enable the use of existing text mining techniques to be applied to very short message mining directly and satisfactory accuracy obtained.

Further, the extension does not change the information contained in the data itself as it only makes use of the information within the data itself for its extension. Thus this extension is unbiased.

Thus the program of the present aspect can provide unbiased extension of data, such as messages, and in particular very short messages, to make them long enough to apply one or more existing text mining techniques currently used for formal long document classification at higher/acceptable levels of accuracy. Alternatively, the program of the present aspect can be used as pre-processing for existing text mining/analysis techniques which can improve the accuracy of those techniques, particularly for shorter text in each single document.

The program of this aspect therefore can address the ‘not long enough’ characteristic of very short messages by converting a very short message by its unbiased enriched form (which results in longer text) without changing the statistic word (word pattern)-topic distribution. This can make it possible for any existing technique used for formal document classification to be applied to very short message classification and better accuracy achieved. In trials, the inventors have found that a 10% accuracy improvement can be readily achieved using embodiments of the present invention as opposed to using the same classification technique without the processing steps of the present aspect.

The program of the present aspect can be advantageous compared to n-gram models as it does not need any training data or pre-training process to generate an n-gram model or n-gram dictionary beforehand. It also does not require any complicated probability calculation as n-gram model does and it can make use of all information of ordered conjoint words to extend the very short message by universal unbiased conjoint of all possible continuous words beyond n-gram without involving any probability or frequency calculation.

Preferably the program further performs the step of, prior to segmenting, performing pre-processing steps to “clean” the data or render its content more appropriate for subsequent textual analysis.

For example, the method may further perform the pre-processing steps of: cleaning the data to remove meaningless characters; and/or interpreting characters or character strings in the data which have no textual meaning into meaningful textual phrases.

In the step of extending, combinations of neighbouring words may be represented as one string with no spaces in between.

Preferably the program further performs the step of analysing the extended data.

Text classification techniques for analysing formal and long documents have been comparatively mature for decades and are able to achieve satisfactory accuracy provided that the data being analysed is sufficiently large. Any such techniques can be used in the analysis step.

Traditional techniques for formal long document classification include statistical methods and machine learning methods, most of which require pre-defined keywords set. This pre-defined keywords set is the key to achieving the satisfactory classification accuracy. A not-well-defined keywords set can lead to inaccurate classification. A small set of techniques do not need the pre-defined keywords set such as Latent Semantic Analysis (LSA), Latent Dirichlet Allocation (LDA), etc. The enriched representation of very short messages is combined with a statistical learning mechanism, such as LDA, and does not need any keywords to be pre-defined. On the contrary, it is able to automatically detect inherent frequent words and word patterns (frequent expressions) in each category automatically.

The program may also perform other known pre-processing steps which aim to address problems associated with the noise in the data, for example: informal expression or varying/less correct grammar; word variations including different forms of abbreviations for the same word, spelling errors, slang, notions used to express information; and/or irrelevant/noisy information.

Preferably the program further performs the step of extracting, from the analysed data, phrases that are used frequently in the textual data. As the textual data has been enriched by combinations of adjacent words, key/frequent terms can be automatically detected. Terms are composed of more than one word; key/frequent terms reflect the frequently used word patterns in specified scenarios.

The program of this aspect inherently makes use of the word context information in addition to word information itself by appending to the fragment all possible ordered combinations of neighbouring words to achieve the unbiased extension. As the information that is used in text mining techniques is the words appearing in the data, the extension applied by the method of this aspect can also capture the relationship between words (which may go further than and be much richer than traditional semantic analysis) and therefore allow extraction of that relationship.

The computer program of the present aspect may include any combination of some, all or none of the above described preferred and optional features.

A further aspect of the present invention provides a system for processing textual data, the system including a memory and a processor, wherein the processor is arranged to: read, from the memory, textual data; segment the data into one or more fragments by selecting each part of the data which is separated from another part by punctuation indicating a conceptual break; extend each fragment of the data by appending to the fragment all possible ordered combinations of neighbouring words.

Preferably the textual data is very short messages, i.e. messages with no more than 300 characters, preferably no more than 200 characters, and most preferably no more than 140 characters (for example “tweets” as used on Twitter®). Alternatively or additionally, the textual data may be messages having no more than 2 sentences (which need not be complete or grammatically correct). Existing methods are generally considered to work well for text longer than these limits, but their accuracy drops greatly when applied to very short messages, particularly those with fewer than 140 characters.

The shorter the textual data or message is, the more variation a text has. Moreover, very short messages tend to be characterised by informal textual usage (both spelling and grammar), which results in greater text variation in actual very short messages compared to formal written text of the same length. The shorter the textual data is (down to a theoretical minimum limit of one word), the more accuracy improvement the system of the present aspect can provide. This is because when traditional methods are applied to short text with large variations very poor accuracy is achieved. As the text starts to become longer and with less variation, the improvements provided by the system of the present aspect will reduce, but can still be significant.

By extending each fragment, the content of the data, particularly if it is short, can be enriched. This enriched representation of the data can be used for model building which can enable the use of existing text mining techniques to be applied to very short message mining directly and satisfactory accuracy obtained.

Further, the extension does not change the information contained in the data itself as it only makes use of the information within the data itself for its extension. Thus this extension is unbiased.

Thus the system of the present aspect can provide unbiased extension of data, such as messages, and in particular very short messages, to make them long enough to apply one or more existing text mining techniques currently used for formal long document classification at higher/acceptable levels of accuracy. Alternatively, the system of the present aspect can be used as pre-processing step for existing text mining/analysis techniques which can improve the accuracy of those techniques, particularly for shorter amounts of data.

The system of this aspect therefore can address the ‘not long enough’ characteristic of very short messages by converting a very short message by its unbiased enriched form (which results in longer text) without changing the statistic word (word pattern)-topic distribution. This can make it possible for any existing technique used for formal document classification to be applied to short message classification and better accuracy achieved. In trials, the inventors have found that a 10% accuracy improvement can be readily achieved using embodiments of the present invention as opposed to using the same classification technique without the processing steps of the present aspect.

The system of the present aspect can be advantageous compared to n-gram models as it does not need any training data or pre-training process to generate an n-gram model or n-gram dictionary beforehand. It also does not require any complicated probability calculation as n-gram model does and it can make use of all information of ordered conjoint words to extend the very short message by universal unbiased conjoint of all possible continuous words beyond n-gram without involving any probability or frequency calculation.

Preferably the processor further performs the step of, prior to segmenting, performing pre-processing steps to “clean” the data or render its content more appropriate for subsequent textual analysis.

For example, the processor may further perform the pre-processing steps of: cleaning the data to remove meaningless characters; and/or interpreting characters or character strings in the data which have no textual meaning into meaningful textual phrases.

In the step of extending, combinations of neighbouring words may be represented as one string with no spaces in between.

Preferably the processor further performs the step of analysing the extended data.

Text classification techniques for analysing formal and long documents have been comparatively mature for decades and are able to achieve satisfactory accuracy provided that the data being analysed is sufficiently large. Any such techniques can be used in the analysis step.

Traditional techniques for formal long document classification include statistical methods and machine learning methods, most of which require pre-defined keywords set. This pre-defined keywords set is the key to achieving the satisfactory classification accuracy. A not-well-defined keywords set can lead to inaccurate classification. A small set of techniques do not need the pre-defined keywords set such as Latent Semantic Analysis (LSA), Latent Dirichlet Allocation (LDA), etc. The enriched representation of very short messages is combined with a statistical learning mechanism, such as LDA, and does not need any keywords to be pre-defined. On the contrary, it is able to automatically detect inherent frequent words and word patterns (frequent expressions) in each category automatically.

The system may also perform other known pre-processing steps which aim to address problems associated with the noise in the data, for example: informal expression or varying/less correct grammar; word variations including different forms of abbreviations for the same word, spelling errors, slang, notions used to express information; and/or irrelevant/noisy information.

Preferably the processor further performs the step of extracting, from the analysed data, phrases that are used frequently in the textual data. As the textual data has been enriched by combinations of adjacent words, key/frequent terms can be automatically detected. Terms are composed of more than one word; key/frequent terms reflect the frequently used word patterns in specified scenarios.

The system of this aspect inherently makes use of the word context information in addition to word information itself by appending to the fragment all possible ordered combinations of neighbouring words to achieve the unbiased extension. As the information that is used in text mining techniques is the words appearing in the data, the extension applied by the method of this aspect can also capture the relationship between words (which may go further than and be much richer than traditional semantic analysis) and therefore allow extraction of that relationship.

The system of the present aspect may include any combination of some, all or none of the above-described preferred and optional features.

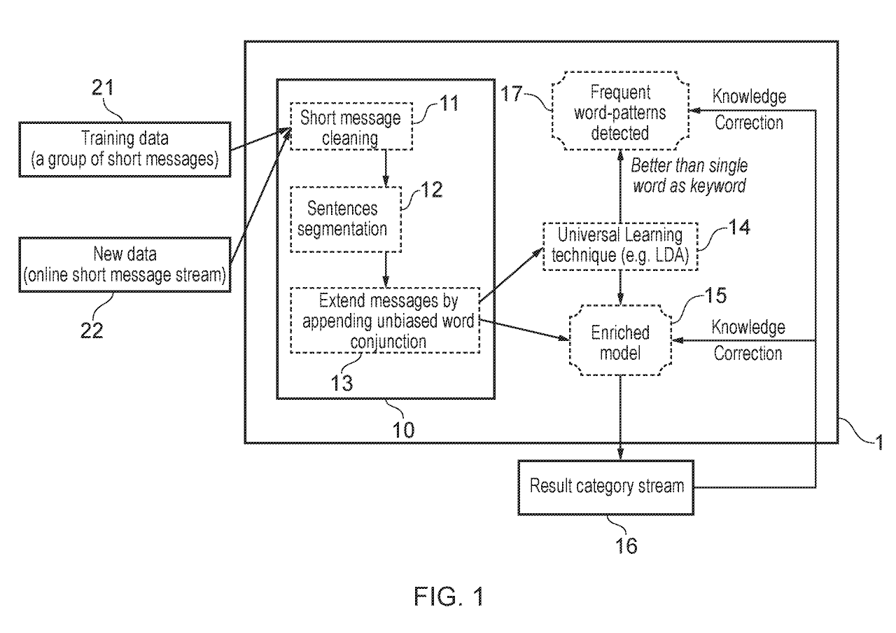

FIG. 1 shows a system according to an embodiment of the present invention.

The steps in a method according to an embodiment of the present invention can be generalised as follows: 1) Message clean-up; 2) Message segmentation; 3) Segment extension; 4) Message analysis. These steps are performed by various processing functions illustrated in FIG. 1, which may be computer programs or routines stored in memory and accessed by a processor.

Message Clean-Up

Very short messages are almost always expressed using informal language. Accordingly as a first step, the data is “cleansed” by eliminating meaningless information.

Example cleansing operations are set out below, although the cleaning step may vary between embodiments and may include some, all or none of these specific operations, as well as other operations which have the effect of either eliminating meaningless characters or interpreting characters or character strings into meaningful textual phrases.

a) removing letters repeated more than twice contiguously (no English word has contiguously repeated letter more than twice—similar rules can be applied for other languages);

b) removing non-informative phrases such as http links and @author in tweets;

c) re-writing strings with no spaces (that might include notions) as meaningful phases, for example, replacing ‘#MerryChristmas’ with ‘merry Christmas’;

d) replacing meaningful notion patterns with word expression, for example to replace ‘:)’ with ‘smiling’ (and similar replacement of other emoticons and abbreviations/slang, such as “lol”);

e) removing non-informative notions, for example removing ‘>>>>>>>’.

In the present embodiment, stop words are not removed. While stop words might not be informative on their own, when they are jointly used with other words they can become meaningful and the message might have a different meaning from that without stop words.

Message Segmentation

After the cleansing process, the very short message has been converted into a combination of meaningful words, spaces and segmentation notions, such as full stops, commas, dashes, etc. . . . The whole message is then segmented into message fragments by notions. The result is that each very short message is represented by a list of sentence segments, and each sentence segment is a combination of meaningful words separated by single space. Each sentence segment is a unit which is used in the subsequent extension step.

Segment Extension

Each sentence segment produced in the segmentation step is extended by appending to it all possible ordered combinations of neighbouring words. Combinations of neighbouring words are represented as one string with no spaces in between.

The message segmentation of the previous step is an important pre-processing step to this extension step as it avoids appending redundant non-informative information. Accordingly, all joint neighbouring words are appended within each sentence segment, and not across different sentence segments. This is because there is generally little relationship/association between neighbouring words across different sentence segments that could enrich the context or meaning. In addition, joining neighbouring words across two or more sentence segments introduces exponentially increasing (and, for the reasons previously indicated, unnecessary) computational burden and can also upset the word association/relationship information.

It should be noted that no additional information outside of the very short message itself is added or indeed is needed either before or after this extension step. Rather, the extension step makes use of the important underlying information carried by the very short message itself (the relationship/association between neighbouring words) to unbiasedly extend and re-form the very short message in order that all the inherent/tacit information is machine readable and can be made use of by automated computational text mining algorithms.

Message Analysis

The previous three steps in the process address the problem that limited information is available in a very short message without changing the information that the message contains. Once these have been carried out, the segmented and extended message can then be processed by any known text analysis technique. In the example below, the well-known statistical learning technique Latent Dirichlet Allocation (LDA) [2] is used with supervised learning.

As shown in FIG. 1, message data is supplied to the pre-processes 10, which form part of the overall analysis package 1. The message data may include training data 21, or may simply be new data 22 for analysis, for example from an online very short message stream such as a Twitter® feed.

The data is first cleaned 11, then segmented 12, then extended 13, as described above. The pre-processed message data can then be passed to a universal learning technique 14 such as LDA, or directly to an enriched model 15 (an enriched model can be obtained from machine learning, e.g. parameters for LDA, or defined from knowledge, e.g. key words/terms). In the embodiment shown, the analysis package aims to classify the incoming data and produces a categorised data stream 16.

The universal learning technique 14 may supply information to a store of frequent word patterns 17, which can be updated and used as a reference in subsequent analysis.

Both the frequent word patterns 17 and the enriched model 15 can be updated or adjusted (if needed) by user interaction based on human analysis of samples from the categorised data stream 16.

### Example 1

A method according to an embodiment of the present invention will be illustrated by reference to an example very short message. This message is assumed to have already undergone the “cleaning” process described as step 1) above.

After the necessary cleaning in step 1) the very short message is “Going to miss the Sweat Squad this week, have fun!” This message is separated into two segments in accordance with step 2) above: {“Going to miss the Sweat Squad this week”; “have fun”}.

In application of step 3), the first segment: “Going to miss the Sweat Squad this week” will be appended by all possible ordered combinations of neighbouring words and becomes:

“Going to miss the Sweat Squad this week Goingto tomiss missthe theSweat SweatSquad Squadthis thisweek Goingtomiss tomissthe misstheSweat theSweatSquad SweatSquadthis Squadthisweek Goingtomissthe tomiss theSweat misstheSweatSquad theSweatSquadthis SweatSquadthisweek GoingtomisstheSweat tomisstheSweatSquad misstheSweatSquadthis theSweatSquadthisweek GoingtomisstheSweatSquad tomisstheSweatSquadthis misstheSweatSquadthisweek GoingtomisstheSweatSquadthis tomisstheSweatSquadthisweek GoingtomisstheSweatSquadthisweek”

Similarly the second segment: “have fun” will be appended by all possible ordered combinations of neighbouring words and becomes:

“have fun havefun”

Then the original very short message is extended and represented by “Going to miss the Sweat Squad this week Goingto tomiss missthe theSweat SweatSquad Squadthis thisweek Goingtomiss tomissthe misstheSweat theSweatSquad SweatSquadthis Squadthisweek Goingtomissthe tomiss theSweat misstheSweatSquad theSweatSquadthis SweatSquadthisweek GoingtomisstheSweat tomisstheSweatSquad misstheSweatSquadthis theSweatSquadthisweek GoingtomisstheSweatSquad tomisstheSweatSquadthis misstheSweatSquadthisweek GoingtomisstheSweatSquadthis tomisstheSweatSquadthisweek GoingtomisstheSweatSquadthisweek, have fun havefun.”

The represented extended text is not understandable by human beings but contains enriched information for all ordered word relationships and/or associations which can be understood and made use of by a machine process. The generation of this enriched text is completely automatic.

### Example 2

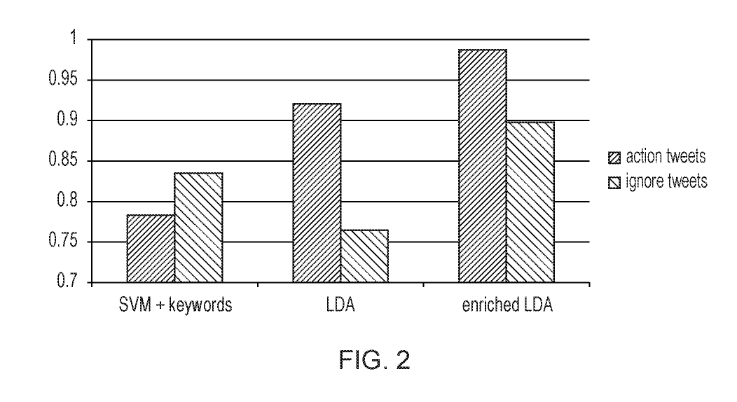

An embodiment of the present invention was used in combination with a traditional statistical method, Latent Dirichlet Allocation (LDA) with supervised learning, to analyse “tweet” s data received by British Telecommunications customer service. The accuracy of various methods in categorizing this “tweet” data is shown in FIG. 2.

The underlying data was collected by the BT customer experience team over a period of approximately 2 years. The customer service team's objective is to classify tweets into two categories: needing action or just ignore. Diagonally hatched bars represent ‘action tweets’ i.e. tweets that require action by the customer service team, e.g. PR report, complaint, inquiries, etc. . . . Horizontally hatched bars represent ‘ignore tweets’ i.e. one for which no action is required, e.g. advertisement, pointless statements, etc. . . .

The original data has been tagged and validated by human customer service agents and is therefore considered to be an accurate categorisation for each tweet. This enables an objective evaluation of the performance (i.e. the accuracy) of any machine categorization approach.

The first results come from use of the BT DebateScape system [3] which uses an SVM method (which is currently used by many companies and researchers for documents/text classification). As shown (“SWM+keywords”), this achieves an accuracy of 78% for action tweets and 83% for ignore tweets.

By using the popular LDA method with the cleansing and pre-processing (steps 1) and 2) above), an accuracy of 92% for action tweets and 72% for ignore tweets is obtained (“LDA”).

By using a method according to an embodiment of the present invention, including cleansing, pre-processing and extension steps, and then using LDA, an accuracy of 98% is achieved for action tweets and 90% for ignore tweets (“enriched LDA”).

As an additional benefit the embodiments of the present invention described above allow the identification of frequent phrases in the messages under analysis, or subsets thereof, in addition to frequent words (which is available from the known LDA output). Detection of such phrases is not possible in existing methods of analysis. Below is an example:

Detected frequent words: house, wait, customer, fixed, getting, virgin, working, services, problems, waiting, told, connection, router, month, home, tweet, sped, btcare, line, openreach, openzone, week, british, days, broadband, hub, sky, deal, live, connect, engineer, weeks, email, fast, mobile, superfast, free, infinity, area, fix, telecom, mbps, months, great, service, calls, box, fibre, optic

Detected frequent terms: bt broadband, bt internet, bt openzone, customer service, bt vision, british telecom, phone line, bt engineer, fibre optic, bt wifi, bt uk, bt infinity

Embodiments of the invention can be used with any other traditional text mining technique and permit such techniques to be applied to very short message classification.

The systems and methods of the above embodiments may be implemented in a computer system (in particular in computer hardware or in computer software) in addition to the structural components and user interactions described.

The term “computer system” includes the hardware, software and data storage devices for embodying a system or carrying out a method according to the above described embodiments. For example, a computer system may comprise a central processing unit (CPU), input means, output means and data storage. Preferably the computer system has a monitor to provide a visual output display. The data storage may comprise RAM, disk drives or other computer readable media. The computer system may include a plurality of computing devices connected by a network and able to communicate with each other over that network.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

In some exemplary embodiments, the data store comprises data received by a receiving computer having receiver circuitry and stored on a computer readable media of the receiving computer or some other computer (e.g., a British Telecommunications customer service computer). In some embodiments, the receiving computer is the same computer system discussed herein that performs the various methods discussed herein. In other embodiments, the receiving computer is in communication via one or more networks, e.g., the Internet, with the computer system discussed herein that performs the various methods discussed herein. In some exemplary embodiments, the receiving computer receives the data stream from one or more other computers, e.g., mobile computers, and stores it as the data store for processing by the computer system. In exemplary embodiments, the analyzed data (e.g., one or more images based on the data) are displayed on a computer system display, such as, a display of the computer system or a display of a remote computer in communication with the computer system.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

In particular, although the methods of the above embodiments have been described as being implemented on the systems of the embodiments described, the methods and systems of the present invention need not be implemented in conjunction with each other, but can be implemented on alternative systems or using alternative methods respectively.

### REFERENCES

[1] Herda\check{g}delen, “Twitter N-Gram Corpus with Demographic Metadata”, in Language Resources and Evaluation, December 2013, Volume 47, Issue 4, pp 1127-1147.
[2] David M. Blei, Thomas L. Griffiths, Michael I. Jordan and Joshua B. Tenenbaum, “Hierarchical Topic Models and the Nested Chinese Restaurant Process”: Advances in Neural Information Processing Systems, 2004. [3] Wanda J. Orlikowski and Simon Thompson, “Leveraging the Web for Customer Engagement: A Case Study of BT's Debatescape”, MIT Sloan Center for Information System Research, 2010.

All references referred to above are hereby incorporated by reference.

1. A method of processing textual data, the method including the steps of:
segmenting the data into one or more fragments by selecting each part of the data which is separated from another part by punctuation indicating a conceptual break;
extending each fragment of the data by appending to the fragment all possible ordered combinations of neighbouring words.

2. A method according to claim 1 further including the step of, prior to segmenting, cleaning the data to remove meaningless characters.

3. A method according to claim 1 further including the step of, prior to segmenting, interpreting characters or character strings in the data which have no textual meaning into meaningful textual phrases.

4. A method according to claim 1 wherein, in the step of extending, combinations of neighbouring words are represented as one string with no spaces in between.

5. A method according to claim 1, further including the step of analysing the extended data.

6. A method according to claim 5, further including the step of extracting, from the analysed data, phrases that are used frequently in the textual data.

7. A computer program which, when run on a computer, performs the steps of:
reading, from a data store or a data stream, textual data;
segmenting the data into one or more fragments by selecting each part of the data which is separated from another part by punctuation indicating a conceptual break;
extending each fragment of the data by appending to the fragment all possible ordered combinations of neighbouring words.

8. A computer program according to claim 7 wherein the program further performs the step of, prior to segmenting, cleaning the data to remove meaningless characters.

9. A computer program according to claim 7 wherein the program further performs the step of, prior to segmenting, interpreting characters or character strings in the data which have no textual meaning into meaningful textual phrases.

10. A computer program according to claim 7 wherein, in the step of extending, combinations of neighbouring words are represented as one string with no spaces in between.

11. A computer program according to claim 7 wherein the program further performs the step of analysing the extended data.

12. A computer program according to claim 11, wherein the program further performs the step of extracting, from the analysed data, phrases that are used frequently in the textual data.

13. A system for processing textual data, the system including a memory and a processor, wherein the processor is arranged to:
read, from the memory, textual data;
segment the data into one or more fragments by selecting each part of the data which is separated from another part by punctuation indicating a conceptual break;
extend each fragment of the data by appending to the fragment all possible ordered combinations of neighbouring words.

14. A system according to claim 13 wherein the processor is further arranged to, prior to segmenting, clean the data to remove meaningless characters.

15. A system according to claim 13 wherein the processor is further arranged to, prior to segmenting, interpret characters or character strings in the data which have no textual meaning into meaningful textual phrases.

16. A system according to claim 13 wherein, when extending, the processor is arranged to represent combinations of neighbouring words as one string with no spaces in between.

17. A system according to claim 13 wherein the processor is further arranged to analyse the extended data.

18. A system according to claim 17 wherein the processor is further arranged to extract, from the analysed data, phrases that are used frequently in the textual data.
